(19) United States
(12) Patent Application Publication
(10) Pub. No.: US 2007/0061745 A1
(43) Pub. Date: Mar. 15, 2007

(54) Nested views in an electronic file system

(75) Inventors: Colin R. Anthony, Buthell, WA (US); Justin Mann, Kirkland, WA (US); Martijn E. Van Tilburg, Seattle, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/222,234

(22) Filed: Sep. 9, 2005

(51) Int. Cl. G06F 9/00

(52) U.S. Cl. 715/764; 715/810; 715/835

(57) ABSTRACT

A live preview of objects in a folder or other container, including sub-folders, is provided, without requiring the user to open the folder or other container. When a user is previewing a set of objects in a closed container, any containers represented in the view may themselves concurrently show to the user a live preview of their contents. This may be displayed concurrently to the user at any number of levels, as desired. Each hierarchical level or container may itself be assigned an individual view that may be different from or the same as other views of other containers. Views may be nested in other views to show the contents of any organizational construct. The contents previews may further be displayed in an intelligent manner that adjusts their layouts based on if they are the primary view of one many nested views.

### BACKGROUND

Electronic file systems conventionally organize a set of objects in a hierarchy, such as a file within a folder, which is in another folder. However, such file systems have user interfaces are typically designed to allow a user to browse one level in the hierarchy at a time. For example, where the user is viewing a system organized into a set of files and folders, many systems require the user to navigate into a folder (i.e., open the folder) to view its contents. Some systems go a step further and allow the user to see pre-constructed thumbnails of the items within a folder without first opening the folder. For example, Microsoft's WINDOWS XP line of operating systems provide such a preview feature by showing a few pre-selected thumbnails of photos stored in a folder while the folder is closed.

However, this preview feature does not provide a live view of what is inside the folder; if a file in the folder is added, removed, or modified, the preview does not necessarily update to show the changes. Moreover, the preview feature does not provide information about what is in folders contained in the folder being previewed. For example, if a first folder contains photos, and if the first folder is contained in a second parent folder, then the preview thumbnail feature when viewing the closed second folder does not provide any information about what is in the first child folder. In addition, the user cannot interact directly with the preview thumbnails shown on a closed folder. Instead, the user must first open the folder in order to interact with the files contained therein.

### SUMMARY

It would be desirable to provide a live, real-time preview of what objects are in a folder or other container, including sub-folders, without requiring the user to open the folder or other container. When a user is previewing a set of objects in a closed container, any containers represented in the view may themselves concurrently show to the user a live preview of their contents. This may be displayed concurrently to the user at any number of levels, as desired.

In addition, each hierarchical level or container may itself be assigned an individual view that may be different from or the same as other views of other containers. For example, a first container may show a thumbnail view, a second container at the same hierarchical level as the first container may show a mantel view, and a third container contained within the second container may show a calendar view. The view for each container may be user-selectable and/or automatically selected by the computer. Thus, views may be embedded, or nested, in other views to show the contents of any organizational construct.

Moreover, while a set of objects may be displayed in accordance with a particular view, they may also be displayed in an intelligent manner that adjusts their layouts based on if they are the primary view of one many nested views. For example, if there are numerous objects in a container, it may be desirable to automatically reduce the number of objects represented in the closed container preview so that the user may be able to see them easily. If too many object thumbnails, for example, are displayed within a closed container preview, then the thumbnails may be too small to provide any useful information to the user.

These and other aspects of the disclosure will be apparent upon consideration of the following detailed description of illustrative embodiments.

### BRIEF DESCRIPTION OF THE DRAWINGS

The foregoing summary, as well as the following detailed description of illustrative embodiments, is better understood when read in conjunction with the accompanying drawings, which are included by way of example, and not by way of limitation with regard to the claimed invention.

FIG. 1 is a functional block diagram of an illustrative computer that may be used to implement various aspects of the present invention.

FIG. 2 is a screenshot showing illustrative closed container representations.

FIG. 3 is a screenshot showing an illustrative open state representation of one of the containers represented in FIG. 2.

FIGS. 4-6 are screenshots showing additional illustrative closed container representations.

FIG. 7 is a screenshot showing an illustrative open state representation of the container represented in FIG. 6.

FIG. 8 is a screenshot showing an illustrative open state representation of a sub-container contained in container represented in FIGS. 6 and 7.

FIGS. 9-12 are screenshots illustratively showing how hierarchies of representations may be interacted with by the user.

### DETAILED DESCRIPTION OF ILLUSTRATIVE EMBODIMENTS

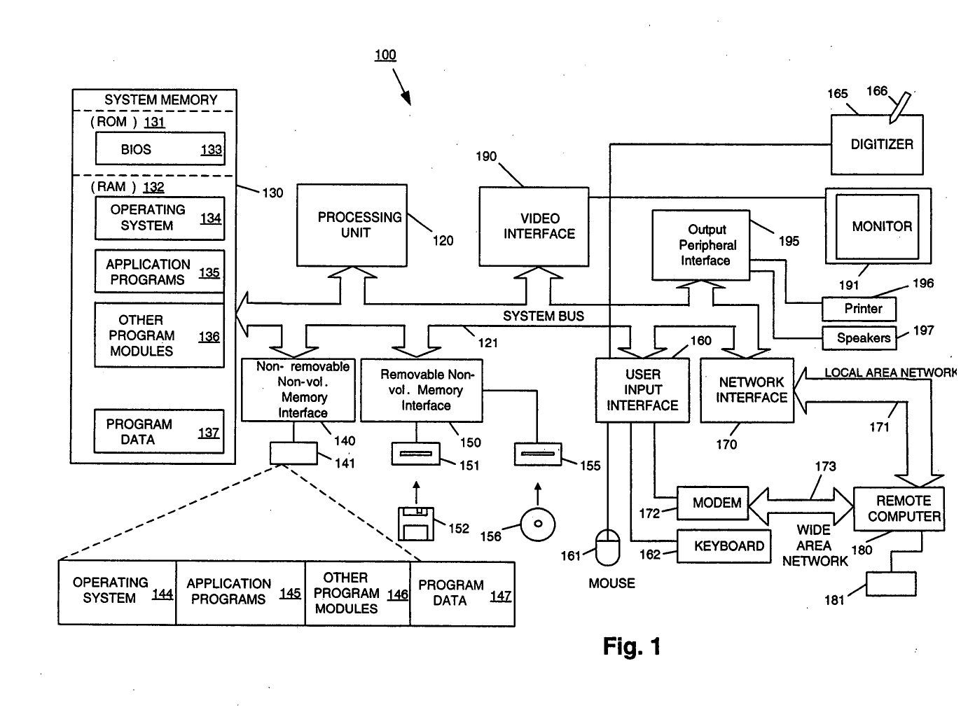

FIG. 1 illustrates an example of a suitable computing system environment 100 in which aspects as described herein may be implemented. Computing system environment 100 is only one example of a suitable computing environment and is not intended to suggest any limitation as to the scope of use or functionality of various aspects as described herein. Neither should computing system environment 100 be interpreted as having any dependency or requirement relating to any one or combination of components illustrated in illustrative computing system environment 100.

One or more other general purpose or special purpose computing system environments or configurations may be used. Examples of well known computing systems, environments, and/or configurations that may be suitable include, but are not limited to, personal computers (PCs); server computers; hand-held and other portable devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

Aspects of the disclosure herein may be described in the general context of computer-executable instructions, such as program modules, stored on computer-readable media and executable by a computer. Generally, program modules include routines, programs, objects, components, data structures, etc. that perform particular tasks or implement particular abstract data types. Embodiments discussed herein may also be operational with distributed computing environments where tasks are performed by remote processing devices that are linked through a communications network. In a distributed computing environment, program modules may be located in both local and remote computer-readable media including memory storage devices.

With reference to FIG. 1, illustrative computing system environment 100 includes a general purpose computing device in the form of a computer 100. Components of computer 100 may include, but are not limited to, a processing unit 120, a system memory 130, and a system bus 121 that couples various system components including system memory 130 to processing unit 120. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus, also known as Mezzanine bus.

Computer 100 typically includes a variety of computer-readable media. Computer readable media can be any available media that can be accessed by computer 100 such as volatile, nonvolatile, removable, and non-removable media. By way of example, and not limitation, computer-readable media may include computer-readable media and communication media. Computer-readable media are tangible media, and may include volatile, nonvolatile, removable, and non-removable media implemented in any method or technology for storage of information such as computer-readable instructions, data structures, program modules or other data. For example, computer-readable media includes random-access memory (RAM), read-only memory (ROM), electrically-erasable programmable ROM (EEPROM), flash memory or other memory technology, compact-disc ROM (CD-ROM), digital video disc (DVD) or other optical disk storage, magnetic cassettes, magnetic tape, magnetic disk storage or other magnetic storage devices, or any other medium which can be used to store the desired information and which can accessed by computer 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF) (e.g., BLUETOOTH, WiFi, UWB), optical (e.g., infrared) and other wireless media. Any single computer-readable medium, as well as any combination of multiple computer-readable media, are both intended to be included within the scope of the term “computer-readable medium” as used herein.

System memory 130 includes computer-readable storage media in the form of volatile and/or nonvolatile memory such as ROM 131 and RAM 132. A basic input/output system (BIOS) 133, containing the basic routines that help to transfer information between elements within computer 100, such as during start-up, is typically stored in ROM 131. RAM 132 typically contains data and/or program modules that are immediately accessible to and/or presently being operated on by processing unit 120. By way of example, and not limitation, FIG. 1 illustrates software in the form of computer-executable instructions, including operating system 134, application programs 135, other program modules 136, and program data 137.

Computer 100 may also include other computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM, DVD, or other optical media. Other computer storage media that can be used in the illustrative operating environment include, but are not limited to, magnetic tape cassettes, flash memory cards, digital video tape, solid state RAM, solid state ROM, and the like. Hard disk drive 141 is typically connected to system bus 121 through a non-removable memory interface such as an interface 140, and magnetic disk drive 151 and optical disk drive 155 are typically connected to system bus 121 by a removable memory interface, such as an interface 150.

The drives and their associated computer storage media discussed above and illustrated in FIG. 1 provide storage of computer-readable instructions, data structures, program modules and other data for computer 100. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137, respectively. Operating system 144, application programs 145, other program modules 146, and program data 147 are assigned different reference numbers in FIG. 1 to illustrate that they may be different copies. A user may enter commands and information into computer 100 through input devices such as a keyboard 162 and a pointing device 161, commonly referred to as a mouse, trackball or touch pad. Such pointing devices may provide pressure information, providing not only a location of input, but also the pressure exerted while clicking or touching the device. Other input devices (not shown) may include a microphone, joystick, game pad, satellite dish, scanner, or the like. These and other input devices are often coupled to processing unit 120 through a user input interface 160 that is coupled to system bus 121, but may be connected by other interface and bus structures, such as a parallel port, game port, universal serial bus (USB), or IEEE 1394 serial bus (FIREWIRE). A monitor 191 or other type of display device is also coupled to system bus 121 via an interface, such as a video interface 190. Video interface 190 may have advanced 2D or 3D graphics capabilities in addition to its own specialized processor and memory.

Computer 100 may also include a touch-sensitive device 165, such as a digitizer, to allow a user to provide input using a stylus 166. Touch-sensitive device 165 may either be integrated into monitor 191 or another display device, or be part of a separate device, such as a digitizer pad. Computer 100 may also include other peripheral output devices such as speakers 197 and a printer 196, which may be connected through an output peripheral interface 195.

Computer 100 may operate in a networked environment using logical connections to one or more remote computers, such as a remote computer 180. Remote computer 180 may be a personal computer, a server, a router, a network PC, a peer device or other common network node, and typically includes many or all of the elements described above relative to computer 100, although only a memory storage device 181 has been illustrated in FIG. 1. The logical connections depicted in FIG. 1 include a local area network (LAN) 171 and a wide area network (WAN) 173, but may also or alternatively include other networks, such as the Internet. Such networking environments are commonplace in homes, offices, enterprise-wide computer networks, intranets and the Internet.

When used in a LAN networking environment, computer 100 is coupled to LAN 171 through a network interface or adapter 170. When used in a WAN networking environment, computer 100 may include a modem 172 or another device for establishing communications over WAN 173, such as the Internet. Modem 172, which may be internal or external, may be connected to system bus 121 via user input interface 160 or another appropriate mechanism. In a networked environment, program modules depicted relative to computer 100, or portions thereof, may be stored remotely such as in remote storage device 181. By way of example, and not limitation, FIG. 1 illustrates remote application programs 182 as residing on memory device 181. It will be appreciated that the network connections shown are illustrative, and other means of establishing a communications link between the computers may be used.

As discussed previously, touch-sensitive device 165 may be a device separate from or part of and integrated with computer 100. In addition, any or all of the features, subsystems, and functions discussed in connection with FIG. 1 may be included in, coupled to, or embodied integrally as part of, a tablet-style computer. For example, computer 100 may be configured as a tablet-style computer or a handheld device such as a PDA where touch-sensitive device 165 would be considered the main user interface. In such a configuration touch-sensitive device 165 may be considered to include computer 100. Tablet-style computers are well-known. Tablet-style computers interpret gestures input to touch-sensitive device 165 using stylus 166 in order to manipulate data, enter text, create drawings, and/or execute conventional computer application tasks such as spreadsheets, word processing programs, and the like. Input may not only be made by stylus 166, but also by other types of styli such as a human finger.

An electronic file system may be implemented by computer 100 to manage files and other objects stored in the various electronic media to which computer 100 has access. The file system may be part of the other program modules 136 and/or part of operating system 134. The file system may be a traditional file system that stores files in a hierarchical tree structure. In such a case, each node of the tree is considered a folder that contains one or more files. The location of a file is limited by, and conflated with, its organization within the file system. This means that file locations and directory structure are dependent on one another; when a file is moved to another location, the directory structure also changes to accommodate the new location of the file.

Alternatively, the electronic file system may be more advanced, such as a database-driven file system. In more advanced file systems, shortcut references may be used, allowing files and other objects to appear in one or more locations while actually being in only one of the locations or even in another, completely different location.

In either case, the electronic file system may define various types of objects that provide a relatively flexible way of managing files and other objects. For example, objects may be broadly divided into containers and non-container objects. In general, containers are objects that contains other objects in the file system, whereas non-container objects typically do not contain other objects from the perspective of the file system. A simple example of a container is a folder (e.g., C:\My Documents), and a simple example of a non-container object is a file (e.g., Project.doc), such as a word-processing document, a photo, or an audio file. In addition to files, other types of non-container objects include, but are not limited to, calendar items, emails, and contacts.

In addition to folders, other types of containers include, but are not limited to, lists, persisted auto-lists, and stacks. A list is an object that references a set of other objects in a particular order. The objects referenced by a list are not actually stored in the list as they are in a conventional folder. Thus, more than one list may simultaneously reference the same object. A persisted auto-list is similar to a list except that the set of objects referenced by a persisted auto-list are determined by a query that defines one or more criteria. Thus, a persisted auto-list is a list containing a set of objects that meet one or more criteria of the query. A stack is a virtual container representing the set of items that meet a given requirement, in accordance with a given organization. For instance, the user may define an organization that stacks a persisted auto-list or query results by “author” and then presents all results organized by who wrote them; a different stack may be presented for each author.

The user may interact with objects in the electronic file system via a graphical user interface. The graphical user interface may cause various visual features to be displayed on a display such as monitor 191. For example, the graphical user interface may include displayed representations of each object, or of a subset of the objects, stored by the electronic file system. A representation may be any visual representation such as an icon or a picture. The graphical user interface may also respond to user input. The user input may be received via any user input device such as mouse 161, digitizer 165 and stylus 166, and/or keyboard 162. In response to such user input, computer 100 interprets the input and determines an appropriate action, which may include adjusting what is displayed in the graphical user interface. For example, where a representation is selected by the user, computer 100 may cause the graphical user interface to visually indicate on monitor 191 that the representation has been selected.

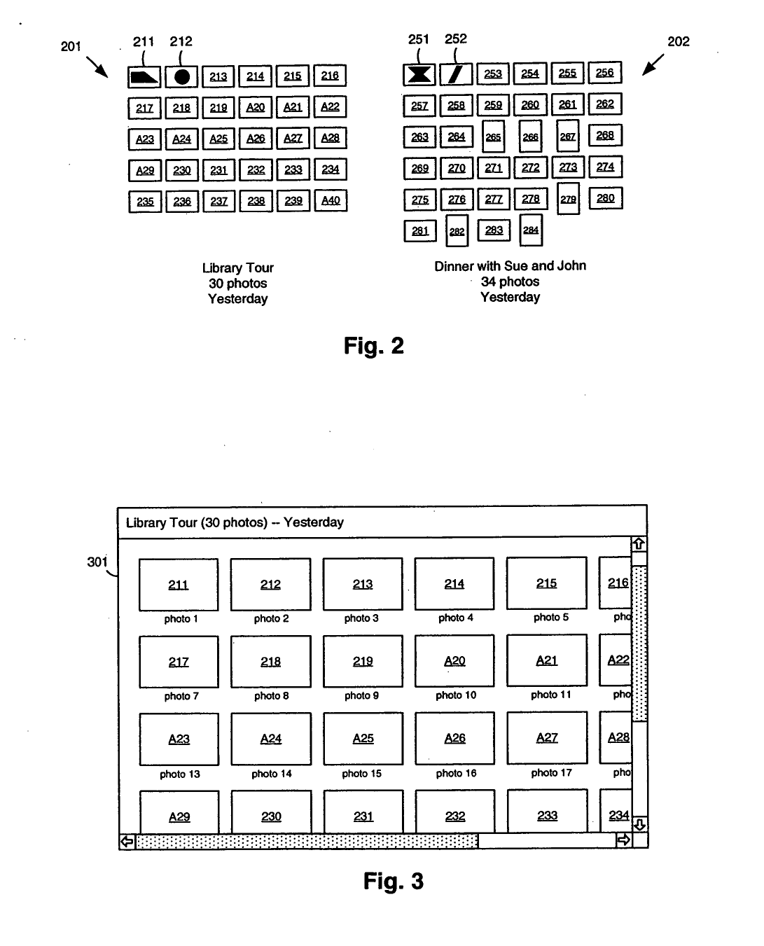

An example of what the user interface may display is shown in FIG. 2. Here, two representations 201, 202 of two container objects are displayed simultaneously with each other. Each container representation 201, 202 may represent a respective folder or other container containing one or more objects. Although two container representations 201, 202 are shown in this example, any one or more separate container representations may be displayed at any given time as desired.

Each container representation 201, 202, in this example, includes a text description of the associated container (e.g., Library Tour, 30 photos, Yesterday). Each container representation 201, 202 as shown also includes a set of further representations 211-240 or 251-284 each associated with a different object contained in one of the containers. The term “contained in” a container as used herein includes both an object actually being located in the container and also the object alternatively being referenced by the container (e.g., where a shortcut to the object is located in the container, such as an object being listed in a list). In this example, the objects in each container are photo files, and representations 211-40 and 251-284 are each a miniature version of the photos stored in one of the files. In other words, representations 211-240 and 251-284 are shown in accordance with a thumbnail view.

Each container may have a particular view associated with that container that is used to display contained objects both when a container is open and when the container is closed. The view for each container may be user-selected or automatically selected by computer 100 (such as via a software application or the operating system). A view as used herein refers to a defined way of displaying object representations to the user. For example, a view may define what representations are to look like, their size, their shape, their relative layout, the quantity of representations to show at any given time in an open and/or closed container state, whether or not they may be interacted with by the user, whether or not textual description is part of or accompanies the representations, and/or what information such textual description should provide. A thumbnail view, for example, would present each object representation as a thumbnail of its content or a portion thereof. For instance, a thumbnail view of a photo file would display a thumbnail of the photo stored in the photo file. A closed container having an assigned thumbnail view would be displayed to have therein a thumbnail of each representation that would be shown in the container if the container were opened.

FIG. 2 shows illustrative container representations 201, 202 where their respective associated containers are closed. In response to the user appropriately selecting representation 201 (such as by double-clicking on it), the associated container may open and a display such as shown in FIG. 3 may be provided. Here, a representation 301, different from representation 201, is displayed that indicates to the user that the associated container is now open. Representation 301 may be, as in the illustrated example, a window. Window 301 may be resizable by the user and may include scroll bars and/or any other features typical of a window. At least some of representations 211-240 are shown in window 301 in accordance with the same view (thumbnail view) as when the container was closed (FIG. 2). In this case, the thumbnail representations 211-240 in FIG. 3 may be larger than in FIG. 2, or they may be identical to those shown in FIG. 2. In addition, textual information about the objects associated with each representation 211-240 may be simultaneously displayed next to each representation. The textual information may include, for example, the title, date, author, subject, and/or any other metadata associated with each object. For instance, the photo file associated with thumbnail representation 211 is entitled “photo 1” and the photo file associated with thumbnail representation 212 is entitled “photo 2.”

Thus, representation 201 in FIG. 2 may be considered a preview of what is shown in FIG. 3. Both show representations 211-240 with the same view—a thumbnail view. Thus, representations 211-240 are displayed as thumbnails, both when the container is closed (FIG. 2) and after the container is opened (FIG. 3).

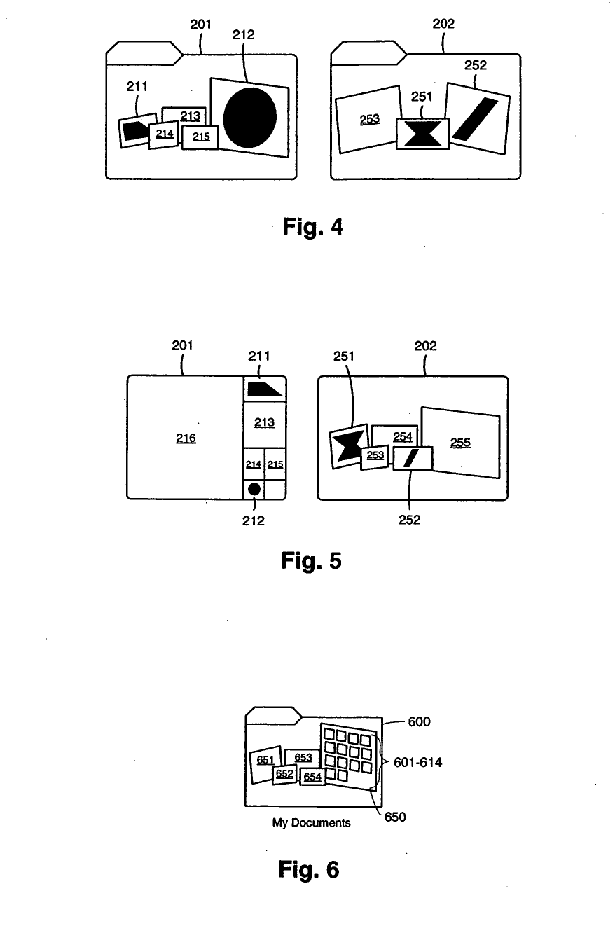

Another example is shown in FIG. 4, wherein representations 201 and 202 this time show representations 211-215 and 251-253 of contained objects in a different view, which is herein referred to as a mantel view. The mantel view shows representations 211-215 and 251-253 as though they were photographs leaning up against a wall, such as on a fireplace mantel. When the container associated with representation 201 (for example) is opened, the same mantel view is again shown to the user, such as in a window. However, in this case, after the container is opened, the photos shown in the mantel view may be larger. Thus, representation 201 as shown in FIG. 4 is actually showing a nested pair of views: a thumbnail view of a mantel view. In other words, a mantel view of a set of object representations is shown in thumbnail form. When the container associated with representation 201 is opened, then the mantel view is shown in full mantel form. The same holds true for the example of FIG. 2; this is also a nested view. In particular, FIG. 2 shows a thumbnail view of a thumbnail view. In other words, a thumbnail view of a set of object representations is shown in thumbnail form. Also, as illustratively shown in FIG. 5, views may be mixed even among various containers displayed simultaneously. For example, representation 201 in this case is a thumbnail view of an album view, while representation 202 is a thumbnail view of a mantel view.

In addition, views may be nested at more than two levels. For example, in FIG. 6 a folder (“My Documents”) is presented to the user as a representation 600 with a thumbnail view therein of a mantel view of a plurality of object representations including a container representation 650. In addition, the mantel view of container representation 650 is further shown having therein a thumbnail view of a plurality of object representations including representations 601-614, and 650-654. Thus, in this example, there are three hierarchical levels of nested views: a thumbnail view of a mantel view of a thumbnail view.

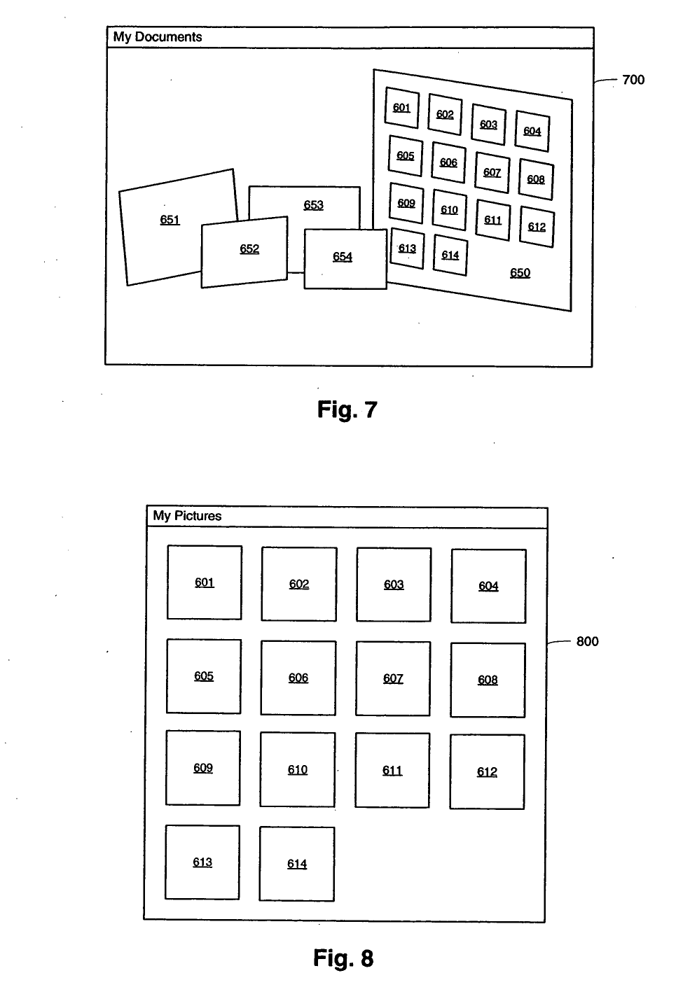

FIG. 6 shows the My Documents folder when in a closed configuration. When the My Documents folder is selected and opened, another representation 700 (such as a window) is shown that shows a magnified version of the mantel view of FIG. 6. The mantel view in FIG. 7 may show the same representations 650-654 and/or different representations. For example, representations 601-614 and 650-654 may each be larger in FIG. 7 than in FIG. 6. Moreover, additional representations may be shown in FIG. 7 than in FIG. 6. This is because although other objects may also be contained within the My Documents folder, there may not have been sufficient room to show all of the representations of all of the objects in the My Documents folder.

If the user were to select representation 650 from FIG. 7 so as to open the container associated with representation 650, then the user may see what is illustratively shown in FIG. 8. In this example, a representation 800 (such as a window) is displayed along with one or more of the object representations 601-614 therein. The thumbnail view of representations 601-614 in FIG. 8 may show the same representations 601-614 and/or different representations. For example, representations 601-614 may each be larger in FIG. 8 than in FIG. 7. Moreover, additional representations may be displayed within representation 800 than in representation 650. This is because although other objects may also be contained within the folder associated with representation 650, there may not have been sufficient room to show all of the representations of all of the objects in the folder associated with representation 650. Thus, computer 100 may have intelligently determined that a smaller number of object representations should be displayed within representation 650, based on, for example, the size, shape, and/or style of representation 650.

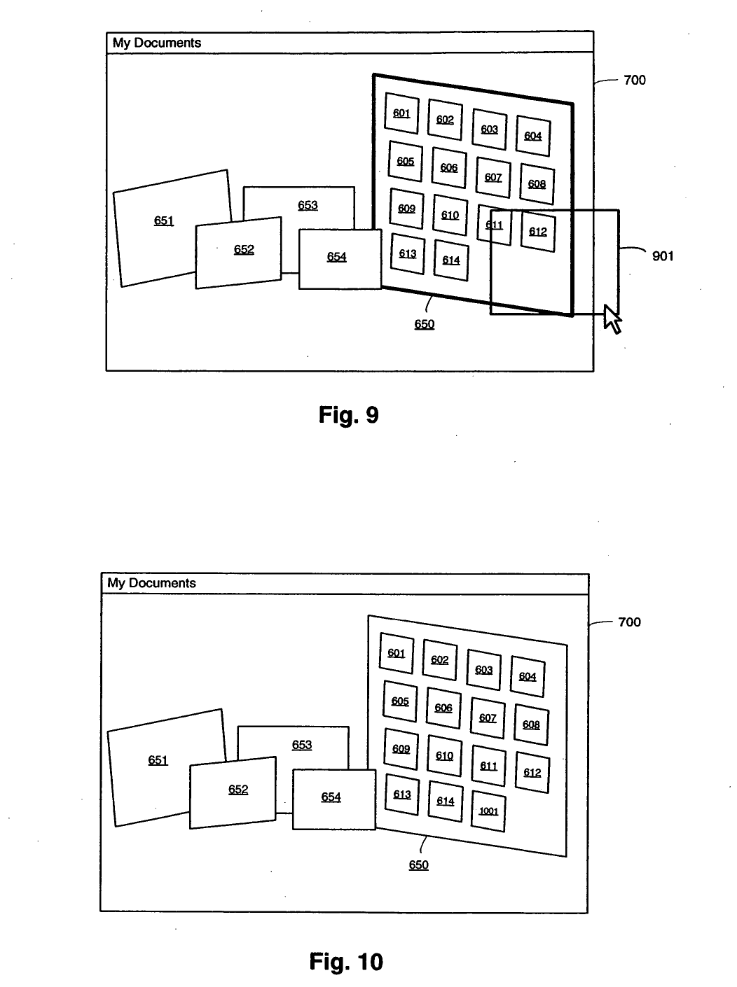

Referring to FIG. 9, representations may be interacted with by the user even though the container that they are in is closed. For example, the user may drag an object representation 901 from outside representation 700 onto representation 650 (which is displayed within representation 700), and then drop representation 901 onto representation 650. In response, computer 100 may cause the object associated with representation 901 to be contained within the container associated with representation 650. This is indicated to the user, for example, by showing representation 1001 associated with the object previously associated with representation 901, as illustratively shown in FIG. 10. Representation 1001 is shown in accordance with the view that is applied to the representations within representation 650, which in this example is a thumbnail view. Where representation 901 was a thumbnail in this example, then representation 1001 may be a smaller version of representation 901.

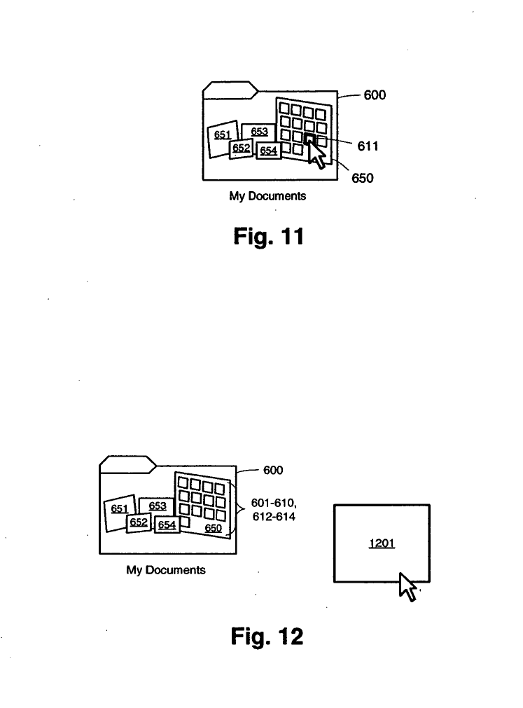

Another example of interacting with representations is discussed in connection with FIGS. 11 and 12. As shown in FIG. 11, the user may select representation 611 (for example) and drag it out of both representations 650 and 600. As a result, as shown in FIG. 12, a representation 1201 may be presented is associated with the same object that was previously associated with representation 611. Representation 1201 may be displayed in accordance with a view that may be different than the view within representation 650. For example, if the user drags onto the desktop, then the desktop may itself be considered a container and have an associated view. Representation 1201 may then be displayed in accordance with the desktop's assigned view. For example, where the desktop view is also a thumbnail view, then representation 1201 may be displayed as a larger thumbnail than representation 611. However, where the desktop view is, e.g., a mantel view, then representation 1201 may be displayed in accordance with the mantel view.

Any changes to the content of a container or non-container object may be updated dynamically to show the changes to the user in real time. For example, in response to the drag/drop operation, representation 611 is removed from being displayed within representation 650. This is because the user's act of dragging and dropping has caused the object previously associated with representation 611 to be removed from the container associated with representation 650. As an alternative to a drag/drop operation, a representation may be selected and cut/copy/paste commands (such as via keyboard shortcuts or menus) may be issued.

Thus, it can be seen that representations at any hierarchical level may be directly interacted with by the user, regardless of whether the container containing the objects associated with those representations is open or closed. As another example, the user may, with reference to FIG. 11, drag representation 611 outside of representation 650 but drop it onto a blank area within representation 600. This would have the effect of moving the object associated with representation 611 from the container associated with representation 650 to the My Documents folder (i.e., in this example, such an action would move the object up a level in the hierarchy).

Thus, an improved graphical user interface has been described herein where a user may obtain useful and interactive preview information without having to open a container in an electronic file system.

What is claimed is:

1. A computer-readable medium storing computer-executable instructions for performing steps, the steps comprising:
(a) receiving a user-selected first view;
(b) displaying a first container representation of a container of an electronic file system concurrently with a first object representation of each of a first plurality of objects, wherein the first object representations are displayed in accordance with the first view, wherein the first object representations are each displayed inside the first container representation, and wherein the first objects are each contained in the container; and
(c) in response to a first user selection of the first container representation, displaying a second container representation of the container different from the first container representation concurrently with a second object representation of each of the first plurality of objects, wherein the second object representations are displayed in accordance with the first view, and wherein the second object representations are each displayed inside the second container representation.

2. The computer-readable medium of claim 1, wherein each of the first plurality objects is a file.

3. The computer-readable medium of claim 1, wherein the first view defines an amount of textual information displayed for each of the first and second object representations.

4. The computer-readable medium of claim 1, wherein the first view defines a quantity of the first plurality of objects.

5. The computer-readable medium of claim 1, wherein the first view defines a size of each of the first and second object representations.

6. The computer-readable medium of claim 1, wherein the first view defines a shape of each of the first and second object representations.

7. The computer-readable medium of claim 1, wherein the second object representations are larger versions of the first object representations.

8. The computer-readable medium of claim 1, further including opening the container in response to the first user selection.

9. The computer-readable medium of claim 1, wherein the container is a folder.

10. The computer-readable medium of claim 1, wherein at least one of the first plurality of objects is a container of the electronic file system.

11. The computer-readable medium of claim 1, wherein the computer-executable instructions are further for:
receiving a user-selected second view different from the first view;
displaying the first container representation concurrently with a third object representation of each of the first plurality of objects, wherein the third object representations are displayed in accordance with the second view, wherein the third object representations are each displayed inside the first container representation, and wherein the third object representations are different from the first object representations; and
in response to a second user selection of the first container representation, displaying the second container representation concurrently with a fourth object representation of each of the first plurality of objects, wherein the fourth object representations are displayed in accordance with the second view, wherein the fourth object representations are each displayed inside the second container representation, and wherein the fourth object representations are different from the second object representations.

12. The computer-readable medium of claim 1, wherein the computer-executable instructions are further for receiving a user-selected second view,
wherein step (b) further includes displaying the first container representation and the first object representations concurrently with a third object representation of each of a second plurality of objects,
wherein the third object representations are displayed in accordance with the second view,
wherein the third object representations are each displayed inside one of the first object representations, wherein the second plurality of objects are contained within one of the objects of the first plurality of objects,
wherein step (c) further includes displaying the second container representation and the second object representations concurrently with a fourth object representation of each of the second plurality of objects, and
wherein the fourth object representations are displayed in accordance with the second view, and wherein the fourth object representations are each displayed inside one of the second object representations.

13. The computer-readable medium of claim 12, wherein the computer-executable instructions are further for, in response to a second user selection of the one of the second object representations, displaying a fifth object representation associated with and different from the one of the second object representations concurrently a sixth object representation of each of the second plurality of objects, wherein the sixth object representations are displayed in accordance with the second view, and wherein the sixth object representations are each displayed inside the fifth object representation.

14. The computer-readable medium of claim 1, wherein the computer-executable instructions are further for:
during step (b), receiving a second selection of one of the first object representations; and
responsive to the second user selection, removing one of the plurality of first objects associated with the one of the first object representations from the container.

15. The computer-readable medium of claim 14, wherein the second user selection includes dragging the one of the first object representations out of the first container representation.

16. The computer-readable medium of claim 1, wherein the computer-executable instructions are further for:
during step (b), receiving a second selection of one of the first object representations; and
responsive to the second user selection, displaying metadata associated with one of the first plurality of objects that is associated with the one of the first object representations.

17. A computer-readable medium storing computer-executable instructions for performing steps, the steps comprising:
displaying concurrently a first container representation of a first container of an electronic file system, a first object representation of each of a first plurality of objects, a second container representation of a second container of the electronic file system different from the first container, and a second object representation of each of a second plurality of objects different from the first plurality of objects, wherein the first object representations are displayed within the first container representation in accordance with a first view, and wherein the second object representations are displayed within the second container representation in accordance with a second view different form the first view;
in response to a first user selection of the first container representation, displaying a third object representation of each of the first plurality of objects, wherein the third object representations are displayed in accordance with the first view; and
in response to a second user selection of the second container representation, displaying a fourth object representation of each of the second plurality of objects, wherein the fourth object representations are displayed in accordance with the second view.

18. The computer-readable medium of claim 17, wherein the first plurality of objects are contained in the first container and the second plurality of objects are contained in the second container.

19. The computer-readable medium of claim 17, wherein the first view defines a quantity of the first plurality of objects and the second view defines a quantity of the second plurality of objects.

20. The computer-readable medium of claim 17, wherein the first view defines a shape of each of the first and third object representations and the second view defines a shape of each of the second and fourth object representations.
